(19) United States
(12) Patent Application Publication
(10) Pub. No.: US 2005/0284830 A1
(43) Pub. Date: Dec. 29, 2005

(54) Modular base deck and display system

(76) Inventors: Mark O. Snyker, Delafield, WI (US); Jack R. Fillmore, Oconomowoc, WI (US)

Correspondence Address: WALLENSTEIN WAGNER & ROCKEY, LTD, 311 SOUTH WACKER DRIVE, 53RD FLOOR, CHICAGO, IL, 60606, US

(21) Appl. No.: 11/061,129

(22) Filed: Feb. 18, 2005

Related U.S. Application Data
(60) Provisional application No. 60/546,523, filed on Feb. 20, 2004.

(51) Int. Cl. B62B 1/00

(52) U.S. Cl. 211/133.4; 280/47.32

(57) ABSTRACT

A transportable base deck for use in a display system comprises a plastic base portion having an upper portion with a generally flat upper support surface. The base portion is generally rectangular. A plurality of legs extend downwardly from the upper portion and are positioned to support the upper portion above a floor. The base deck is configured to act as a side deck or an end deck to the display system, or to stand alone or back to back with another base deck. The base deck can include a back stop wall extending downwardly from the rear portion of the upper portion of the base portion toward the floor. The base deck can also include an interface for connecting the base deck to a display system.

### CROSS-REFERENCE TO RELATED APPLICATIONS

This Application claims the benefit of U.S. Provisional Application No. 60/546,523 filed Feb. 20, 2004, the contents of which are herein incorporated herein by reference. This Application is being filed concurrently with U.S. patent application Ser. No. ______ (“Coupling System for Modular Base Deck and Display System,” Attorney Docket No. 4112P098) which also claims the benefit of the above Provisional Application.

### FEDERALLY SPONSORED RESEARCH OR DEVELOPMENT

N/A

### TECHNICAL FIELD

The present invention generally relates to base decks utilized with display systems and more particularly, to mobile plastic base decks having a back stop wall and including an interface for coupling the base deck to the display system.

### BACKGROUND OF THE INVENTION

Display systems, sometimes referred to as gondolas, typically include a frame structure and a plurality of shelves (or other display formations, e.g., hooks or pegs for hanging items) supported by the frame structure. The frame structure typically includes a main upright wall panel supported by legs extending outwardly from both sides of the bottom of the panel. An end wall panel is sometimes connected at one or both ends of the main wall panel and is positioned perpendicular to the main wall panel. This gives the display system an “I” (if both ends include an end wall) or “T” (if only one end includes an end wall) top plan view. The display systems are typically used in retail stores and other similar facilities to position and display product.

The frames of the display systems preferable allow for shelving on both sides of the system and at both ends. However, some display systems may be placed with a side or end against a wall or other structure—thus limiting the amount of shelving or other display structure in the system.

The display systems include base decks that are configured to act as the lowest or ground level shelves of the system. The base decks are typically metal shelves that rest on or are supported by the legs of the frame, or include additional support. These metal shelves are securely fixed to the frame structure.

The prior display systems required store personnel to bring products to the display system via a cart, or a wood or plastic pallet carried by a hand or mechanical fork lift, and load the products onto the base decks and other shelving structure. If it was desired to remove or reorganize the placement of such products, the store personnel would again have to use the cart or pallets and forklifts to unload the products from the base decks, and transport them to a new location.

The base area of the display system is subject to abuse. The store personnel or outside venders delivering products for placement in the display systems, can harm the base area when loading or unloading such products, or by contacting the base area with the carts, forklifts, etc., used to bring the products to the system from a back storage or warehouse area of the store. Additionally, the base area can be abused from shoppers hitting this area with their shopping carts.

The present invention is provided to solve the problems discussed above and other problems, and to provide advantages and aspects not provided by prior systems of this type. A full discussion of the features and advantages of the present invention is deferred to the following detailed description, which proceeds with reference to the accompanying drawings.

### SUMMARY OF THE INVENTION

The present invention is directed toward various aspects relating to improved base decks as well as to modifications to display systems utilizing the improved base decks. The base decks are configured either for placement on the side of a display system and may be referred to herein as side decks, or at the end of the display system and may be referred to herein as end decks. Additionally, in some applications the base decks may be used as stand alone units, or may be placed deck to deck without association to a display system. Many of the concepts disclosed herein with respect to one of a side deck or an end deck may be transferable to the other.

The base decks of the present invention comprise a structural deck portion and offsets. The deck portion is used to support various types of loads, such as products to be displayed in a display system. The offsets (such as legs, feet and/or wheels) are used to position the base deck relative to the floor, rack or transport systems. Additionally, various features are shown or described and discussed herein relating to aesthetics, identification, protection, positioning, signage, ergonomics, safety, reparability, recycle ability, and dimensional adaptability of the base decks and display systems.

The present invention is also directed to systems for interfacing (sometimes referred to as “docking”) a mobile base deck with the frame of a display system. The interface provides a means to position and/or secure the base deck proximate the display frame and/or to prevent unintentional dislodgement or significant movement of the base deck when associated with a display system. The interface concepts shown include both active and passive means of connecting one or more of the front edge, back edge, side edges, bottom offsets, or top surface of the base deck to the display system's frame.

The base decks of the present invention include a plastic base portion that can be created from a recycled or recyclable plastic. The base deck also includes a deck portion that can also be created from a recycled or recyclable plastic or can include other materials, such as metal, wood or composites.

The base decks of the present invention can be transported to and from various locations within a retail/distribution environment without having to transfer goods/products to and from other pallets or container systems (which typically require the use of large material handling equipment). Thus, goods can be transferred from loading docks, warehouses, storage locations or other areas of a retail store more easily without the use of equipment, or at least without using large equipment.

In accordance with one embodiment of the present invention, a transportable base deck for use in a display system comprises a plastic base portion having an upper portion with a generally flat rectangular upper support surface. The base portion includes a front portion, a rear portion opposing the front portion, a first side and a second side opposing the first side. A plurality of legs extend downwardly from the upper portion and are positioned to support the upper portion above a floor. The legs can be plastic, and can be integrally formed with the upper portion of the base portion, or can be connectable to the upper portion, for example, by a snap-fit connector, or a bolt. The base deck also includes a back stop wall extending downwardly from the rear portion of the upper portion of the base portion toward the floor. The back stop wall prevents forks from a hand cart or fork lift from extending beyond the rear portion of the base deck and accidentally moving, and/or tipping over, a display system or other object immediately behind the base deck when lifting and/or moving the base deck. The back stop wall can also be plastic and integrally formed with the upper portion.

The base deck can be used as a side deck for a display system. The display system includes an upright planar wall, a first leg extending outwardly from a lower portion of a first side of the planar wall at a first location and a second leg extending outwardly from the first side of the planar wall portion at a second location. Similar legs can extend from the second side of the planar wall. It is contemplated that it is likely more than two display legs per side will be used depending on the overall length of the system The base deck is configured to fit between the first leg and the second leg extending from the planar wall. Similarly, other base decks can fit between sets of consecutive legs extending from the planar wall.

The base deck can include a first wing extending outwardly from the first side of the upper portion of the base deck. The first wing is configured to cover at least a portion of the first leg extending from the planar wall of the display system (preferably about half of the leg so that a wing from another base deck on the other side of the leg covers the remaining portion). The base deck also includes a second wing extending outwardly from the second side of the upper portion of the base portion. Similar to the first wing, the second wing is configured to cover a portion of the second leg extending outwardly from the planar wall of the display system.

The base deck can include a first wheel and a second wheel extending downwardly from the upper portion of the base portion of the base deck. The wheels can be incorporated in the legs extending downwardly from the upper portion, or can be used in place of the legs. The wheels can be unidirectional to help slide the base desk into a slot defined by two display legs. Alternatively, the wheels could be omni-directional and provide assistance in transporting the base deck to or from the display system.

The upper portion of the display system can include one or more scuff guards about an outer periphery. The scuff guards protect the base deck from abuse due to carts or other objects colliding into the deck.

The base portion of the base deck can be utilized to support products directly on its upper surface, or an upper deck portion can be connected to the upper portion or be formed integral with the upper portion. The upper deck portion can be formed from wood, metal and/or a composite material.

According to another embodiment of the invention, a transportable base deck comprises a generally rectangular base portion having a plastic upper portion supported by a plurality of legs extending downwardly from the upper portion. An upper deck having a support surface is connected to the upper portion. The upper deck can be provided with a plurality of perforations. The perforations can be used to facilitate fastening the upper deck to the base portion, or for positioning and fastening objects to the upper deck. For example, signage or dividers can utilize the perforations to connect to the upper deck.

Additionally, the base deck can include one or more reinforcing members. The reinforcing members can be secured to the upper portion of the base deck, as needed to support heavy goods placed on the deck and limit the amount of deflection of the deck.

The transportable base deck further comprises a mechanism for coupling the base deck to a display system. In this regard, both the base deck and the display system can be configured to include components to allow the base decks to interface with the display system in either a side deck position or an end deck position.

In accordance with one embodiment of the present invention, a transportable base deck for use in a display system having a docking mechanism in the form of at least one hook member appending from the display system is disclosed. The transportable base deck comprises a base portion, an upper surface, a front portion, a rear portion, and opposing side portions.

The base deck also comprises an engagement feature provided to interface with a docking mechanism of a display system. In this instance the docking mechanism of the display system includes at least one corresponding hook member. The engagement feature comprises a notch disposed in the rear portion of the base deck and provided to guide and secure a hook member therein. The notch can include opposed inwardly tapered sidewalls to assist in guiding the hook member therein. The notch includes a catch mechanism disposed proximate a terminal end of the notch. The catch mechanism is provided to receive at least a portion of a corresponding hook member disposed on a display system.

In accordance with one embodiment of the present invention, the catch mechanism comprises a lip portion. The lip portion being provided to receive at least a portion of a corresponding hook member disposed on a display system. The base deck can also include a base plate disposed proximate the terminal end of the notch, wherein the base plate defines the lip portion of the engagement feature.

Alternatively, the catch mechanism can comprise a bar extending across at least a portion of the notch. Accordingly, the bar will receive at least a portion of a corresponding hook member disposed on a display system. The catch mechanism could alternatively comprises a spring biased latch in which the latch engages and secures at least a portion of a corresponding hook member disposed on a display system.

In one embodiment of the present invention, the notch may be centrally disposed in the rear portion of the base deck. Alternatively, the base deck may further comprise a plurality of legs extending downwardly from the upper deck portion for supporting the upper deck portion above the floor. According to such an embodiment, each of the legs of the base deck can include a separate notch provided to guide and secure a corresponding hook member from a display system.

In accordance with yet another embodiment of the present invention, a transportable base deck for use in a display system having a pocket member appending therefrom is disclosed. The transportable base deck comprises a base portion, an upper surface, a front portion, a rear portion, and opposing side portions.

The base deck also has an engagement feature provided to interface with the pocket member of the display system. The engagement feature comprises at least one foot projecting downwardly from the base portion of the base deck which cooperatively engages the pocket member of the display system. In one embodiment, the foot is centrally disposed on the rear portion of the base deck.

In accordance with still another embodiment of the present invention, a coupling system is disclosed. The coupling system comprises a docking mechanism having at least one position holding feature and a corresponding engagement feature provided to cooperatively receive the at least one position holding feature. The position holding feature is adapted to be disposed on a display system, and the engagement feature is disposed on a transportable base deck.

According to one embodiment the position holding feature comprises at least one hook member adapted to be attached proximate a bottom portion of a display system. The engagement feature of this embodiment comprises at least one notch disposed in the rear portion of the base deck. Each notch includes a catch mechanism disposed proximate a respective terminal end. The catch mechanism is provided to receive at least a portion of a corresponding hook member disposed on a display system.

The catch mechanism can include a lip portion, a bar or a ring that receives at least a portion of a corresponding hook member disposed on a display system. Alternatively, the catch mechanism can be a spring biased latch that engages and secures at least a portion of a corresponding hook member disposed on a display system.

According to another embodiment, the position holding feature comprises at least one pocket member adapted to be attached proximate a bottom portion of a display system. According to this embodiment, the engagement feature comprises at least one corresponding foot projecting downwardly from the base portion of the base deck. Each foot cooperatively engages a corresponding pocket member when the interface is actively engaged.

The pocket member is defined by a front surface and opposed side walls. The front surface can have an upwardly and inwardly canting frontal plane.

The base decks and display systems disclosed herein may be in a variety of sizes and configurations. Additionally, while shown and discussed primarily as a display system designed for retail merchandizing, the structures described are not limited by application but include and can be incorporated in modular bases and interfaces with any type of fixture or base.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a perspective view of an embodiment of a base deck of the present invention for use as either a side deck or an end deck for a display system;

FIG. 2 is a perspective view of base decks positioned as side decks to a panel wall of a display system;

FIG. 3 is an exploded perspective view of an embodiment of a base deck of the present invention;

FIG. 4 is a partial exploded perspective view of an embodiment of a base deck of the present invention;

FIG. 5 is a perspective view looking up at a bottom of an embodiment of a base deck in accordance with the present invention;

FIG. 6 is a side view of an embodiment of a base deck with wheels;

FIG. 7 is side view of another embodiment of a base deck with wheels;

FIG. 8 is a side view of yet another embodiment of a base deck with wheels;

FIG. 9 is a perspective view of a transportable base deck having a hook lead-in for securing the base deck to the display system;

FIG. 10 is a perspective view of a transportable base deck having an open back with a hook nest for securing the base deck to the display system;

FIG. 11 is a perspective view of a transportable base deck having a hook nest in the legs of the base deck for securing the base deck to the display system;

FIG. 12 is a perspective view of a transportable base deck having a centrally located rear leg hook for securing the base deck to a hook on the display system;

FIG. 13 is a perspective view of a transportable base deck having a centrally located rear foot for placement in a pocket connected to a docking plate on a display system;

FIG. 14 is a partial top plan view of an base deck and docking plate with an alternative pocket;

FIG. 15 is perspective view of a further alternative pocket connected to the docking plate;

FIG. 16 is a perspective view of the transportable base deck of FIG. 9 and display system without a docking plate;

FIG. 17 is an exploded perspective view looking up at an alternative embodiment of the base deck of FIG. 5;

FIG. 18 is a perspective view looking upward at a display system with hook blocks configured to rest on the floor; and,

FIG. 19 is a perspective view of the display system of FIG. 18 with a docking plate positioned between the hook blocks.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The present invention is directed to a base deck for use in a display system and to a display system incorporating one or more of the base decks as side decks and/or end decks. In an alternative embodiment of the invention, the base deck can be utilized as a stand alone structure, or can be positioned back-to-back with a second base deck to display products. The base deck of the present invention is intended to be easily transportable so that goods or products placed on the base deck can be easily moved from a back of the store warehouse to the display system, or from one display system to another, or from one position on a display system to another by simply moving the entire deck. The base decks are also designed to be durable and be able to withstand abuse, such as—for example—collisions with shopper's carts.

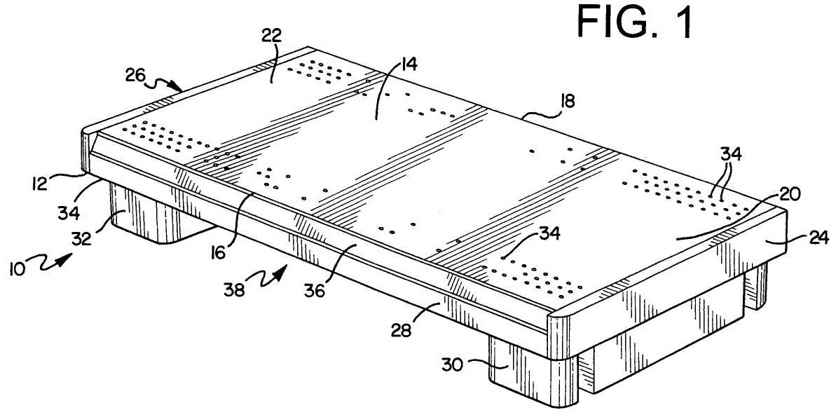

FIG. 1 shows one embodiment of a base deck 10 in accordance with the present invention. The base deck 10 of FIG. 1 is used as an end deck, i.e., connected to or positioned at an end of a display system (however, it can also be used as a side deck with only slight modifications). The base deck 10 includes a plastic base portion 12 and a deck portion 14 connected to the top of the base portion 12. The base deck 10 has a generally rectangular shaped supporting surface; however, other shapes are possible. The base deck 10 includes a front portion 16 and a rear portion 18. When used with a display system, the rear portion 18 is placed against an end wall of the display system (or against the main wall of the display system if used as a side deck). The base deck 10 extends from a first side 20 to a second side 22.

The base deck 10 includes a first end cap 24 connected to the first side 20, and a second end cap 26 connected to the second side 24. The first and second end caps 24, 26 act as scuff guards to protect the base deck 10 from collisions which may result when transporting the base deck 10, or from shopper's carts, etc. The front portion 16 of the base deck 10 includes a front scuff rail 28. The end caps 24, 26 and scuff rail 28 (these elements can also be referred to as “bumper rails”) can be a separate pieces connected to the base deck 10 (e.g., by a snap-fit, bolts, etc.). Alternatively, the end caps 24, 26 and scuff rail 28 can be plastic that is integrally formed (e.g., molded) with the base portion 12. If the base deck 10 is used as a side deck for a display system, the end caps can be removed, or the base deck can be formed without the end caps.

The base portion 12 of the base deck 10 includes one or more legs 30, 32 extending downwardly from an upper portion 35 of the base portion 12 that supports the deck portion 14. In the embodiment shown in FIG. 1, the legs 30, 32 are positioned proximate the first and second sides 20, 22, and extend from the front portion 16 to the rear portion 18 of the base deck 10. The legs 30, 32 can be plastic that is integrally formed with the upper portion 34, or can be separate pieces connected to the upper portion 34 (e.g., by a snap-fit, bolts, etc.). The legs 30, 32 are sufficiently spread apart to create an open portion 38 (i.e., a “free span”) through which forks from a hand cart or forklift can be inserted to move and transport the base deck 10. This also facilitates cleaning under the deck.

Preferably, the base portion 12 of the base deck 10 is formed from recycled plastics. One possible base portion 12 is made by modifying half of a plastic pallet to include the features of the base deck 10 described herein. Alternatively, the base portion can be formed to size in a molding process.

The deck portion 14 can be metal and may include perforations 34 for draining any liquid spilled on the base deck 10. Additionally, an angled label rail 36 can be formed in the deck portion 14. Product identification and pricing information can be placed in the label rail 36. In an alternative embodiment, the deck portion 14 can be plastic and can be either a separate piece secured to the base portion or can be integrally formed with the base portion 12. In further alternative embodiments, the deck portion 14 can be wood, or a composite material, or a combination of different materials.

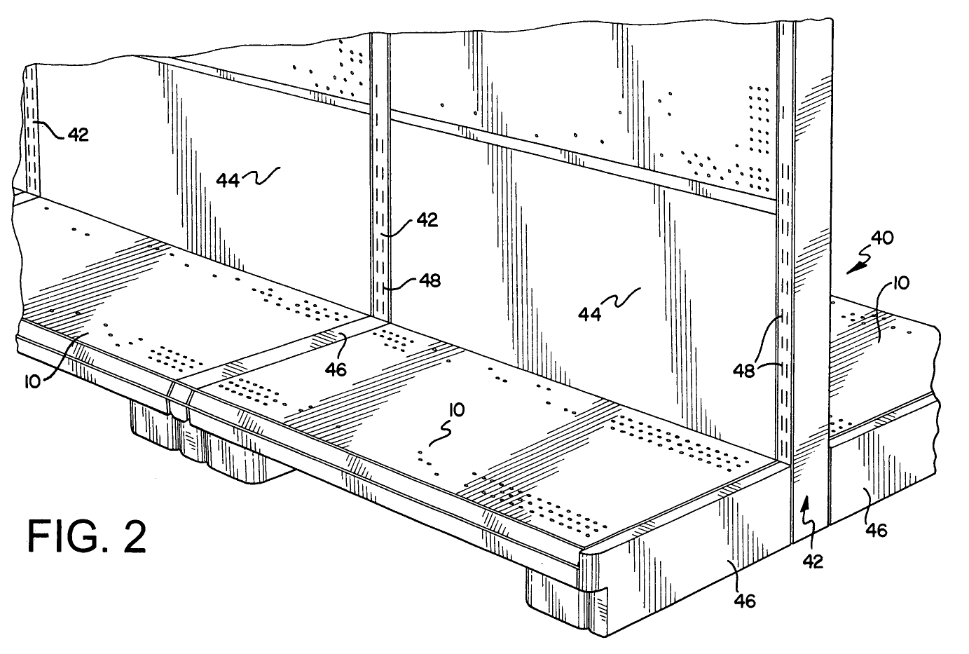

Referring to FIG. 2, a plurality of base decks 10 are utilized as side decks to a display system 40. The display system 40 includes a plurality of vertically positioned rails 42 which support one or more wall sections 44. The rails 42 and the wall sections 44 collectively form a main wall structure of the display system 40. The rails 42 can be formed from an extruded plastic or metal, or other suitable materials. The rails 42 are formed with a plurality of slots 48 to accommodate shelving brackets for placement of additional shelves above the base decks 10.

A plurality of display legs 46 extend outwardly from either side of the lower portions of the rails 42 to support the wall structure in an upright position. This structure is referred to as a “T Frame.”

Each base deck 10 is positioned between two of the display legs 46 to collectively form a continuous bottom shelf for the system 40. As shown in FIG. 2, the upper surfaces of the base decks are flush with the upper surface of the display legs to form a continuous shelf at the bottom of the display system. In an alternative embodiment disclosed in more detail below, the base decks 10 include wings extending from the sides of the base deck 10 which are configured to extend over and cover the display legs 46. The display legs 46 and/or the rails 42 and/or the wall sections 44 can be constructed out of similar materials or have similar colors with the base decks 10 in order to aesthetically match with the base decks 10.

The display system 40 disclosed in FIG. 2 does not include an end wall or an end deck. However, an end wall and/or docking structure can be positioned perpendicular to the main wall at the end of the system, and a base deck 10 can be placed against the system 40 as an end deck. Unlike the side decks, an end deck is exposed on both sides. This is why the base deck is sometimes provided with end caps.

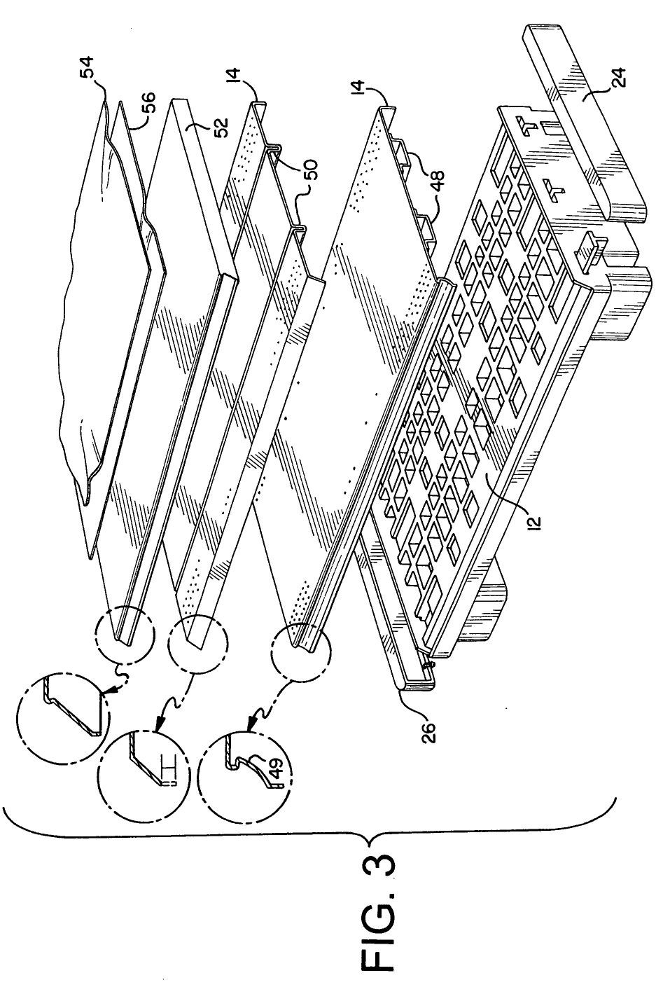

FIG. 3 shows an exploded view of another embodiment of a base deck 10 in accordance with the present invention with a plurality of possible deck portions 14. The base portion 12 is shown as half of a plastic pallet with scuff guards or end caps 24, 26 at each side of the base portion 12. The first deck portion 14 (shown immediately above the base portion) includes a first metal section having perforations and structural channels 48 connected to the lower surface of the metal section. This deck portion can be formed to include a progressive die rolled beveled edge 49. An alternative “lower cost” deck portion 14 having structural grooves 50 is shown immediately above the first metal section. In a further alternative, (above the portion with grooves 50) a deck portion could also be a molded plastic 52 (which may be structural foam, or may be blow molded or injection molded). This molded plastic could also be combined with one of the metal sections shown below. Finally, a film 54 and/or sheet layer(s) 56 can be placed on top of the molded plastic deck portion 52 and/or metal deck portions 14. The film/sheets may include graphics.

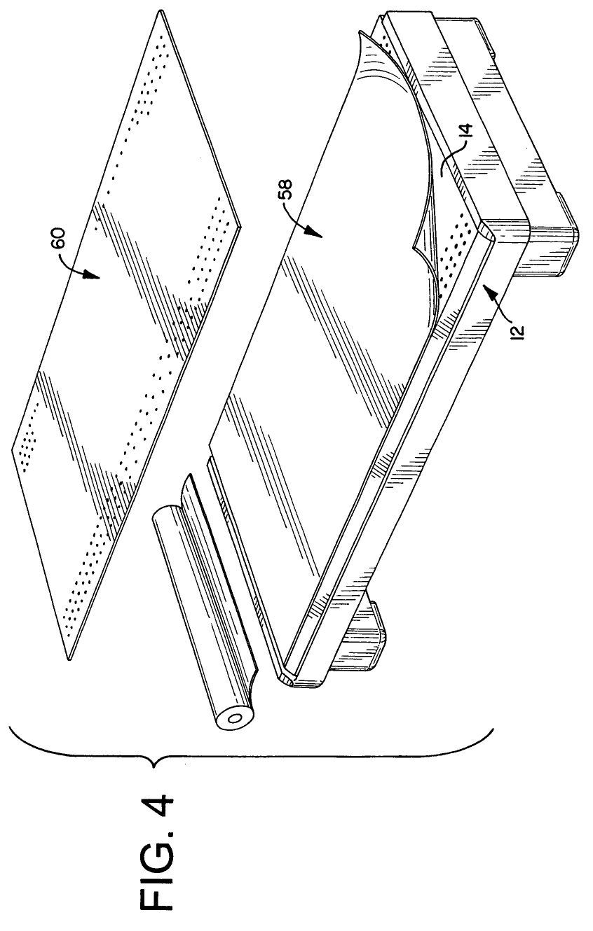

FIG. 4 shows an exploded view of another embodiment of a base deck 10 in accordance with the present invention with recyclable deck trim. The deck trim includes a film 58 (e.g., paper, plastic, foil) cut to size to fit across the upper surface of the deck portion 14. The film may include a low tack adhesive to allow for easy removal. Alternatively, mechanical fasteners can be used to hold the film 58 in place. A cover 60 (e.g., a durable plastic sheet) can be placed over the film 58, or simply placed on the base deck without the film 58.

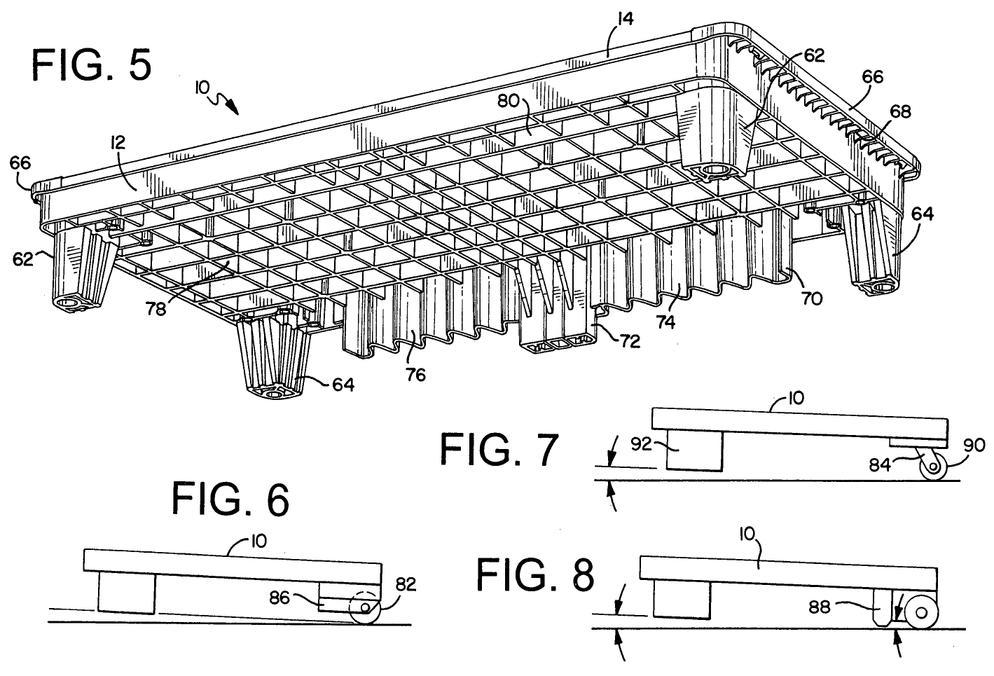

In an embodiment shown in FIG. 5, a base deck 10 is shown with a plastic base portion 12 that is combined with or includes an integral plastic upper deck portion 14. The base deck 10 includes two front legs (or feet) 62 and two rear legs 64 extending downwardly from the upper portion of the base portion 12. The two front and two rear legs 62, 64 are snap-fitted to the base deck 10; however, these legs could also be integral (i.e., molded) with the base portion 12. The base deck 10 can be used as an end deck or a side deck without modification.

Each side of the base deck 10 includes an upper deck wing 66 that extends outwardly from the deck. The deck wings 66 are preferably plastic and are integral with the upper deck portion 14. The deck wings 66 are configured to extend over a portion of display legs 46 that are positioned on either side of the base deck 10 when used as a side deck to the display system 40. In this regard, the wings 66 should be sized to extend half way across the display leg 46 so that, coupled with a wing from an adjacent side deck, the display legs 46 are completely covered and a continuous bottom or base shelf is formed by the side decks.

In terms of the embodiment of the base deck shown in FIG. 2, the height of the base deck 10 of FIG. 5 must be increased (or the height of the display legs 46 decreased) to allow the wings 66 to fit over the display legs 46. The wings 66 can be provided with ribs 68 on the underside of the wing 66 to increase strength.

The rear portion of the base deck 10 of FIG. 5 includes a back stop wall 70 extending downwardly from the upper portion of the base portion 12. The back stop wall 70 is positioned between the two rear legs 64. The back stop wall 70 is used to prevent forks from a hand cart or fork lift from extending past the base deck 10 when the base deck 10 is transported or otherwise maneuvered. This is to prevent the forks from contacting an object, such as the wall of the display, and tipping the object over when the forks are moved upward to lift and hold the base deck 10 off the floor.

The back stop wall 70 is formed from plastic and is integrally part of the base portion 12. The base deck 10 also includes an integral or snap-fit rear center leg 72. The center leg 72 separates the back stop wall 72 into a first wall portion 74 and a second wall portion 76. The center leg 72 acts as middle wall portion to create a continuous wall; however, the back stop wall 70 only needs to be in areas where a fork may be used. The center leg 72 can be used for additional support for the base deck or can be utilized to dock with the display system as described below.

The back stop wall 70 can extend to the floor, or can be just short of the floor to allow ease of cleaning in that area.

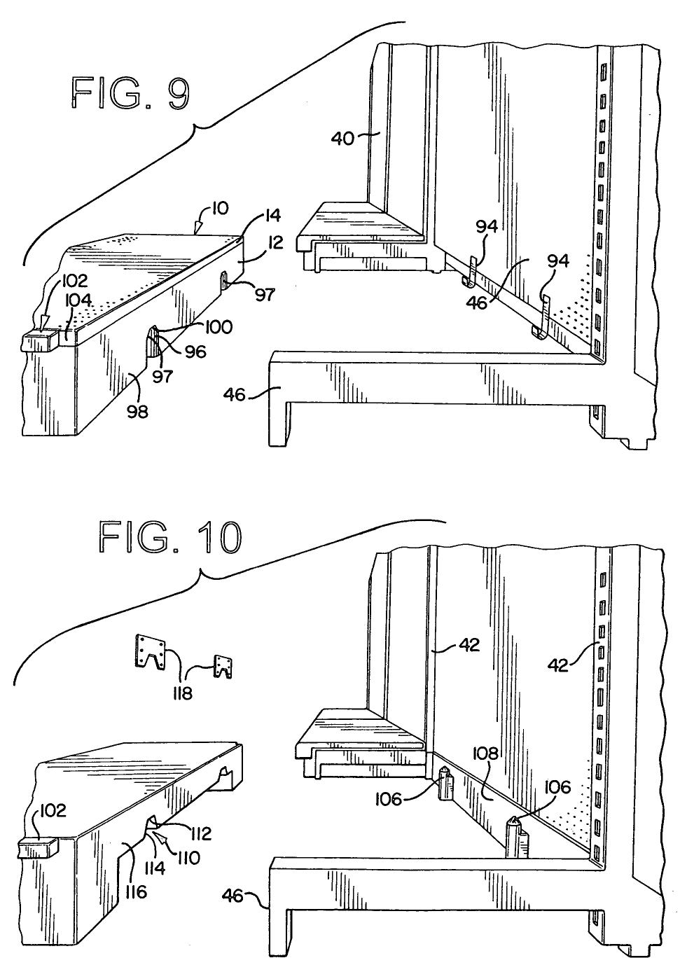

The back stop wall 72 of FIG. 5 is shown having a wave or scalloped pattern. This provides more strength than a flat wall of equal thickness; however, a the back stop wall could be flat as shown in FIG. 9.

The base portion 12 of the base deck 10 includes ribs 78 to provide additional strength to the base deck 10. If more strength is required for a particular use, the base deck 10 is provided with a reinforcing member 80, such as a metal bar or tube. More than one reinforcing member can be used. Similarly, additional legs can be added to provide support.

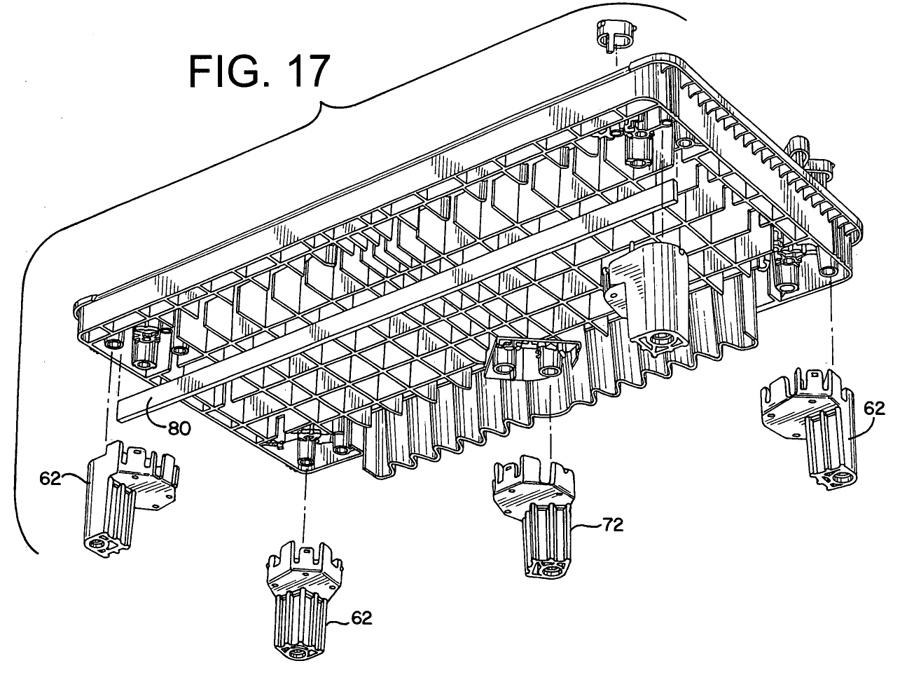

FIG. 17 discloses an exploded view of a similar base deck 10 to that shown in FIG. 5. In this instance, each of the legs 62, 72 is snap-fitted to the base portion of the base deck 10.

As shown in FIGS. 6 and 7, transport of the base decks is preferably facilitated by incorporation of a set of wheels 82 (e.g., in the deck legs), or casters 84 within the base deck 10. In the embodiment of FIG. 6, a set of wheels 82 is mounted to the base deck at a leg portion 86 of the base deck 10. According to one example, one or two wheels 82 are mounted to outer leg portion 86, and one or two wheels 82 are mounted to a center leg portion of the base deck 10. To maneuver the base deck, a front portion of the base deck is tilted rearwardly to lift at least a portion of the base deck from contact with a floor surface upon which the base deck is resting. This allows the base deck to be maneuvered via the wheels. The base deck 10 is configured to allow it to be tilted without a rear portion of the base deck interfering with the floor. The base deck can be configured for various tilt angles required to allow movement of the base deck. In this embodiment, the wheels 84 maintain contact with the floor when the base deck 10 is in a stationary, or flat position. In alternate embodiments, the base deck can include one or more floor pads 88 that maintain contact with the floor until the base deck is tilted rearwardly, as shown in FIG. 8.

In FIG. 7, an embodiment is shown incorporating a set of casters 84, which facilitate extended maneuverability, especially when no equipment is utilized. A base deck may include a set of casters comprising four casters, one disposed at each corner of the base deck. Alternatively, either a front portion of the base deck or a rear portion of the base deck can incorporate one or more feet while the other respective portion incorporates one or more casters. In the example shown in FIG. 7, the front portion of the base deck can include a set of legs or feet 92 while the rear portion of the base deck can include a set of casters. Thus, when the front portion of the base deck is tilted rearwardly to lift the feet from a floor upon which the base deck is resting, the base deck will be free to be moved via the casters 84. Because the casters 84 can pivot about their axes a full 360 degrees of rotation, the base deck 10 can be easily maneuvered.

Referring to FIG. 9, an embodiment of an interface configuration between a base deck 10 and a portion of the display system 40 is disclosed. This embodiment can be incorporated into side deck or end deck applications. In this embodiment, a docking mechanism includes at least one position holding feature in the form of a hook member 94 connected to a wall or frame portion 46 of the display system 40. The hook member 94 interfaces with an engagement feature 96 of the base deck 10.

As shown in FIG. 9, the engagement feature 96 is in the form of a lip portion that the hook member can engage. In this embodiment, the engagement feature 96 includes a notch portion 97 formed within a rear wall 98 of the base deck 10 to provide a guide or lead-in for the hook member 96. The base deck 10 shown in the embodiment disclosed in FIG. 9 includes a pair of notch portions 97 and lip portions 100 to facilitate engagement with a pair of hook members 94. In an alternate embodiment, the engagement feature 96 can be in the form of a bar, a hook, a latch, a ring or other feature that provides engagement with the hook member 94. In yet another embodiment, one or more of the hook members 94 can be optionally removed to add flexibility to the system.

In the embodiment shown in FIG. 9, the rear wall 98 of the base deck is preferably a fully closed design, i.e., extending from a deck portion of the base deck down to a floor surface upon which the display system is placed. This fully closed rear wall 98 acts as a back stop wall (as described above) and prevents an extension of a pallet truck or fork lift from extending past the rear wall and accidentally engaging other portions of the display system. This is important in instances, such as that shown in FIG. 16 where the display system 40 does not include a docking plate, and instead has an open area 41 below the wall portion 46. The back wall stop 98 prevents forks from entering the open area 41. In the embodiment of FIG. 16, no hooks are shown. In this case, the wall 46 and the display legs 42 keep the deck 10 in place.

The deck portion 14 of the base deck includes a pair of side overhang portions or wings 102. Each wing 102 is configured to be disposed over at least a portion of one of a pair of display system legs. In an embodiment, the overhang portions can be removable. The deck portion 14 also includes a pair of notched portions 104 to provide clearance for a vertical frame member of the display system.

Referring now to FIG. 10, yet another embodiment of an interface configuration between a base deck 10 and a portion of the display system 40 is disclosed. Again, this embodiment can be incorporated into side deck or end deck applications. In this embodiment, a docking mechanism includes at least one position holding feature in the form of a hook member 106 integrated into a docking plate 108 as shown in FIG. 10. The hook member 106 interfaces with an engagement feature 110 of the base deck 10.

The embodiment shown in FIG. 10 includes a pair of hook members 106 that are each configured to engage one of a pair of engagement features 110 of the base deck 10. The engagement feature 110 of this embodiment includes a lip portion 112 that is configured to be engaged by the hook member 106. The engagement feature 110 includes a notch portion 114 formed within a rear wall 116 of the base deck 10 to provide a guide or lead-in for the hook member 106 to engage the lip portion 112. In an embodiment, a metal plate 118 can be disposed on the rear wall of the base deck at each of the notch portions 114 to provide rigidity to the lip portion that will resist wear. Alternatively, the metal plate 118 can form the lip portion itself. In an alternate embodiment, the engagement feature can be in the form of a bar, a hook, a latch, a ring or other feature that provides engagement with the hook member.

Unlike the embodiment shown in FIG. 9, the rear wall 116 of the base deck 10 in the embodiment shown in FIG. 10 is not a fully closed design. A fully closed design is not necessary in this embodiment because the docking plate 108 will prevent an extension of a pallet truck or fork lift from accidentally engaging other portions of the display system. The docking plate 108 can be of a fixed length dimension or adjustable as with other embodiments previously described. As with some of the other embodiments, the upper deck portion 14 of the base deck includes a pair of side overhang portions or wings 102 configured to be disposed over at least a portion of a display system leg 46.

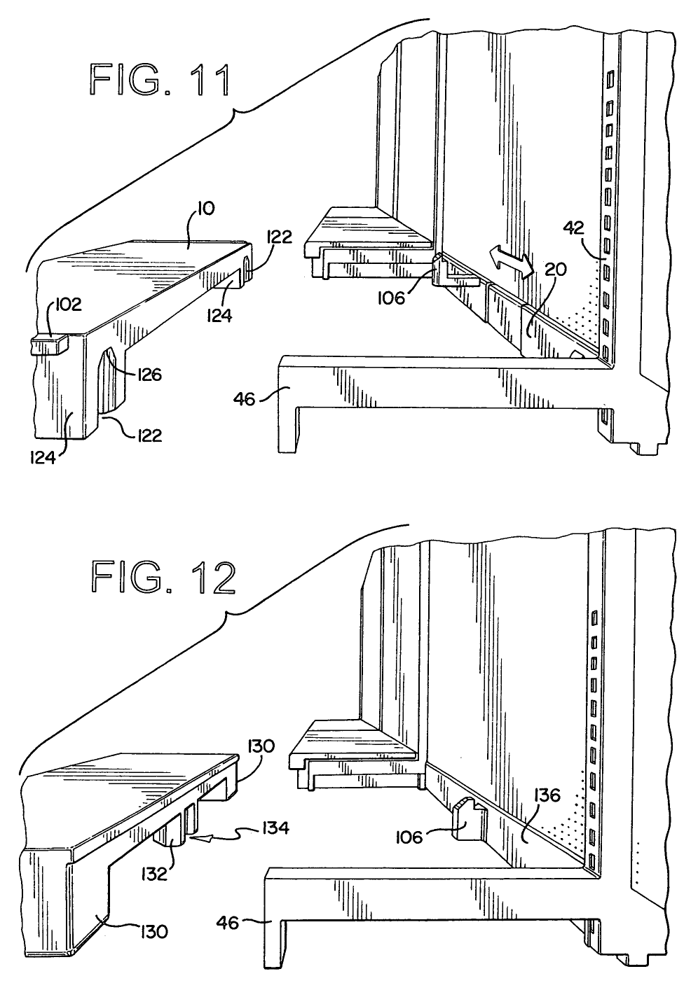

Referring now to FIG. 11, yet another embodiment of an interface configuration between a base deck and a portion of the display system is disclosed. In this embodiment, a docking mechanism includes at least one position holding feature in the form of a hook member 106 integrated into a docking plate 120 as shown in FIG. 10. However, unlike the docking plate 108 of FIG. 10, the docking plate 120 shown in FIG. 11 is adjustable wherein the hook members 106 can be slid outward or inward to accommodate the location of the corresponding engagement features in the base deck 10. The engagement feature of this embodiment is in the form of a slot or pocket 122 formed in the leg portions 124 of the base deck 10. The slot 122 includes a lip portion 126 that is configured to be engaged by the hook member 106. The slot or pocket 122 provides a guide for the hook member 106 during assembly. In an assembled state, the hook member is disposed within the slot or pocket with the lip portion engaged by the hook member.

Referring to FIG. 12, an embodiment is shown utilizing a base deck 10 having a pair of side leg portions 130 and a center leg 132 disposed between the side leg portions 130. In this embodiment, the center leg 132 includes an engagement feature 134 that is configured to be engaged by a position holding member in the form of a hook member 106 connected to, or integrally formed with, a docking plate 136.

The three-leg 130, 132 base deck 10 provides more support and stability by virtue of the presence of the center leg 132. Additionally, because the engagement feature 134 is incorporated into the center leg 132 rather than the other legs, the stability and support properties of other legs can be enhanced without being encumbered by the engagement features. Additionally, the base deck 10 of this embodiment provides an open-front design which allows for access under the base deck for cleaning of a floor upon which the display system is placed.

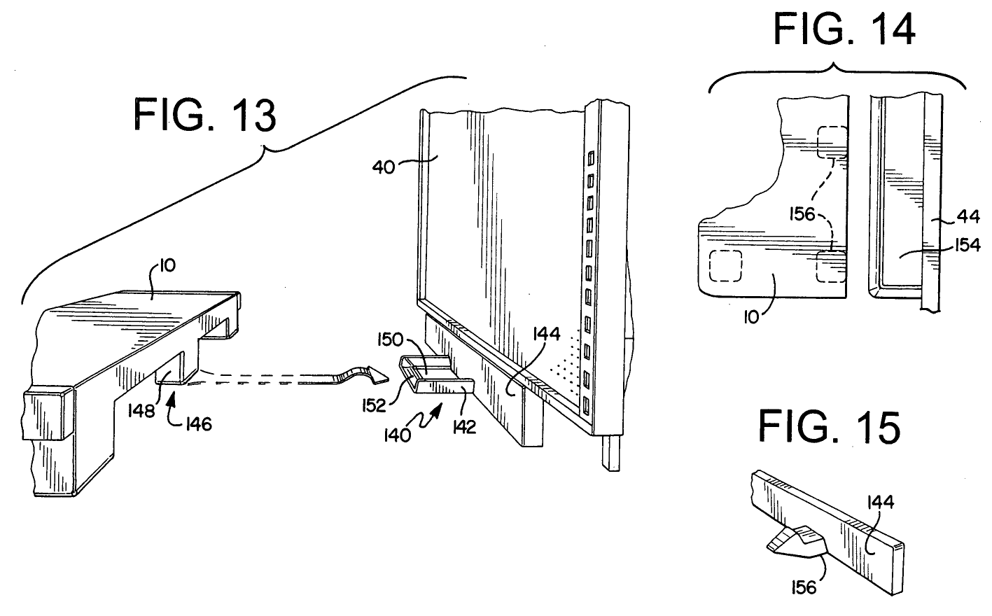

Referring to FIG. 13, yet another embodiment of an interface configuration between a base deck 10 and a portion of the display system 40 is disclosed. As with previously disclosed embodiments, this embodiment can be incorporated into side deck or end deck applications. In this embodiment, a docking mechanism 140 connected to the display system 40 incorporates a position holding feature in the form of a pocket member 142 connected to or integral with a docking plate 144. A corresponding engagement feature 146 in the form of a foot or leg 148 of the base deck 10 is configured to be captured by a pocket 150 formed within the pocket member 142 as the base deck 10 is placed into position relative to the display system 40. The pocket member 142 preferably includes an angled transition surface 152 to facilitate translation of the foot 148 into the pocket 150 of the pocket member 142. In alternate embodiments, more than one pocket member at more than one location against the display system could be utilized to capture more than one foot of the base deck. Additionally, a single pocket member 154 could be configured to be large enough to run along an entire length dimension of the docking plate as shown in the top plan view in FIG. 14. In such a configuration, the single pocket member 154 could capture several feet 156 of the base deck 10.

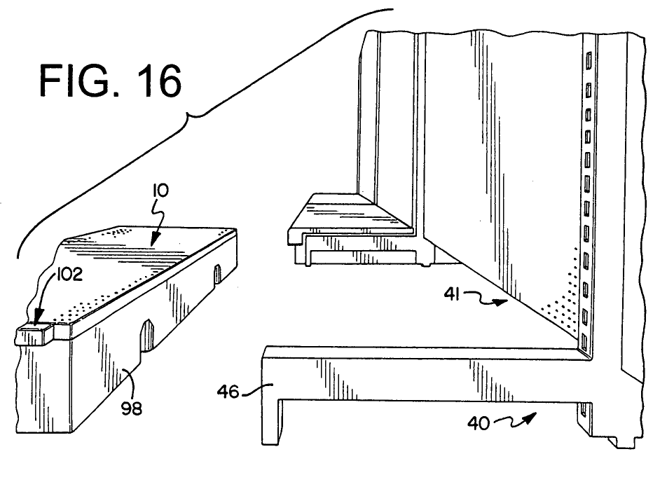

In yet another alternate embodiment, a pocket member as shown in FIG. 15 could be utilized, wherein the pocket member is in the form of a ramped hook 156 having a notched portion, or pocket, to capture a foot of the base deck 10. The pocket member does can be two or more sides and does not have to fully enclose the leg to function properly. In this regard a plate or tube having a bent “L” shape (or one where the upright portion of the “L” is slanted) can create a pocket area without any sides.

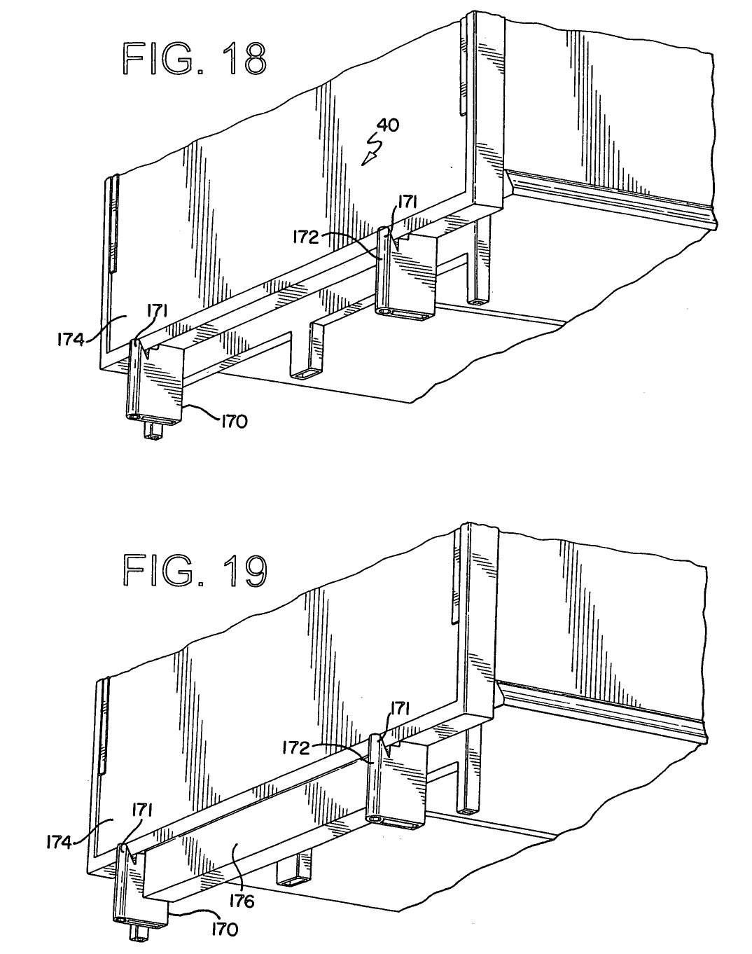

Referring to FIGS. 18 and 19, a display system 40 is shown with a first hook block 170 and a second hook block 172 positioned to receive a base deck (such as the base deck shown in FIGS. 5 and 17) as an end deck to the system 40. The hook blocks 170, 172 are configured to rest on the floor under the end wall panel 174. The hook blocks can be connected to the wall 174 or to the frame or legs of the system. The hook blocks 170, 172 include a hook portion 171 for contacting an engagement feature of the base deck.

The positioning of the hook blocks allows weight from the base deck (and whatever is on the base deck) to be transferred to the ground rather than to the end wall 174 or frame elements of the display system 40. This is of particular importance for base decks having heave loads. FIG. 19 shows a docking plate 176 positioned between the first and second hook blocks 170, 172.

Material handling equipment, such as a hand pallet jack, or a fork lift, having two forks extending outwardly is used to transport or maneuver the base deck 10. In this regard, the forks are inserted through the open front portion 38 (between the front legs or feet) of the base deck 10, and are lifted upward to contact the underside of the base portion 12 to lift the base deck 10 upward and support it during transport. In the embodiment shown in FIGS. 5 and 9, the base deck 10 includes a back stop wall extending below the bumper rail zone toward the floor. The back stop wall is positioned to prevent the forks of the hand pallet jack or fork lift from extending beyond the rear of the base deck 10 when lifting or maneuvering the base deck 10. This prevents the forks from passing all the way through the base deck 10 and accidentally lifting an object behind the base deck 10, such as the frame of the display system 40, or another base deck, and tipping that object. The back stop wall can extend to the floor or can extend just short of the floor to allow a clearance for cleaning accessibility. Moreover, if the rear portion 18 of the base deck 10 includes a center leg the back stop wall can be formed in a first part and a second part on either side of the center leg. Alternatively, one or two legs in the rear portion 18 of the base deck 10 can be positioned to act as a back stop wall and prevent passage of the forks. The back stop wall can be integrally formed in the base deck 10.

When material handling equipment is utilized, certain features may be incorporated into the system of the present invention to enhance usage of such equipment. For example, a docking bay may be incorporated into one or more of the docking mechanisms and/or docking plates previously described. The docking bay includes a floor pad to help stabilize the display system during maneuvering and installation (docking) of a base deck within the display system. The docking bay may also incorporate one or more of the other aspects of the invention, including one or more position holding or locking features previously described. Additionally, one or more alignment legs can be incorporated into a floor pad to aid in alignment of the base deck during docking.

Any number of the aspects of the present invention described herein can be incorporated into a single embodiment, either alone or in combination with other aspects of the invention.

While the specific embodiments have been illustrated and described, numerous modifications come to mind without significantly departing from the spirit of the invention, and the scope of protection is only limited by the scope of the accompanying claims.

1. A transportable base deck for use in a display system comprising:
a plastic base portion having
an upper portion with a generally flat upper support surface, the base portion having a front portion, a rear portion opposing the front portion, a first side and a second side opposing the first side;
a plurality of legs extending downwardly from the upper portion positioned to support the upper portion above a floor; and,
a back stop wall extending downwardly from the rear portion of the upper portion of the base portion toward the floor.

2. The transportable base deck of claim 1 wherein the back stop wall is plastic and is integrally formed with the upper portion.

3. The transportable base deck of claim 1 wherein the plurality of legs are plastic and are integrally formed with the upper portion of the base portion.

4. The transportable base deck wherein the plurality of legs are snap fitted to the upper portion of the base portion.

5. The transportable base deck of claim 1 wherein the base deck is a side deck for a display system having an upright planar wall, a first leg extending outwardly from a lower portion of a first side of the planar wall at a first location and a second leg extending outwardly from the first side of the planar wall portion at a second location, the base deck configured to fit between the first leg and the second leg extending from the planar wall.

6. The transportable base deck of claim 1 further comprising:
a first wing extending outwardly from the first side of the upper portion of the base deck, the first wing configured to cover a portion of the first leg extending from the planar wall of the display system, and a second wing extending outwardly from the second side of the upper portion of the base portion, the second wing configured to cover a portion of the second leg extending outwardly from the planar wall of the display system.

7. The transportable base deck of claim 1 further comprising a first wheel extending downwardly from the upper portion of the base portion of the base deck.

8. The transportable base deck of claim 1 further comprising a scuff guard about an outer periphery of the upper portion of the base portion of the base deck.

9. The transportable base deck of claim 1 further comprising an upper deck portion connected to the upper portion of the base portion of the base deck.

10. The transportable base deck of claim 9 wherein the upper deck portion comprises a sheet comprising at least one of wood, metal and a composite material.

11. The transportable base deck of claim 1 further comprising a mechanism for coupling the base deck to the display system.

12. A transportable base deck comprising:
a generally rectangular plastic upper portion supported by a plurality of legs extending downwardly from the upper portion; and,
an upper deck having a support surface connected to the upper portion.

13. The transportable base deck of claim 12 wherein the upper deck comprises a metal sheet.

14. The transportable base deck of claim 12 wherein the upper deck comprises a composite material.

15. The transportable base deck of claim 13 wherein the upper deck includes a plurality of perforations.

16. The transportable base deck of claim 12 wherein the upper deck comprises a wood portion.

17. The transportable base deck of claim 12 further comprising a reinforcing member secured to the upper portion of the base deck.

18. The transportable base deck of claim 12 wherein the plurality of legs are plastic and are integrally formed with the upper portion.

19. The transportable base deck of claim 12 further comprising a back stop wall extending downwardly from a rear portion of the upper portion.

20. The transportable base deck of claim 12 further comprising a feature for coupling the base deck to a display system.
